(19) United States
(12) Patent Application Publication
(10) Pub. No.: US 2018/0273861 A1
(43) Pub. Date: Sep. 27, 2018

(54) DETERGENT ADDITIVE FOR FUEL

(71) Applicant: TOTAL MARKETING SERVICES, Puteaux (FR)

(72) Inventor: Julie PREVOST, Lyon (FR)

(73) Assignee: TOTAL MARKETING SERVICES, Puteaux (FR)

(21) Appl. No.: 15/761,362

(22) PCT Filed: Sep. 15, 2016
(86) PCT No.: PCT/FR2016/052325

§ 371 Date: Mar. 19, 2018

(30) Foreign Application Priority Data
Sep. 18, 2015 (FR) 1558829

(51) Int. Cl. C10L 1/196; C10L 10/04; C10L 10/06; C08F 293/00

(52) U.S. Cl. CPC C10L 1/1963; C10L 10/04; C10L 10/06; C10L 2250/04; C10L 2270/023; C10L 2270/026; C08F 293/005

(57) ABSTRACT

The use of a copolymer as a detergent additive in an internal combustion engine liquid fuel. The copolymer obtained by copolymerization of at least: an alkyl acrylate or alkyl methacrylate monomer ma and a styrenic monomer mb chosen from styrenics derivatives, the aromatic ring of which is substituted by at least one group R or at least one linear or branched C₁ to C₁₂ hydrocarbon-based chain substituted by at least one group R being chosen from: the hydroxyl group, a group —OR′, a group —(OC_{y}H_{2y}O)_{f}—H, a group —(OC_{y}H_{2y}O)_{f}—R′, a group —O—(CO)—R′, and a group —(CO)—OR′, where y is an integer ranging from 2 to 8, f is an integer ranging from 1 to 10, and R′ is chosen from C₁ to C₂₄ alkyl chains. Also, a process for maintaining the cleanliness of and/or for cleaning at least one of the internal parts of an internal combustion engine.

The present invention relates to the use of a copolymer as detergent additive in a liquid fuel for an internal combustion engine. The invention also relates to a process for keeping clean and/or for cleaning at least one of the internal parts of an internal combustion engine.

### PRIOR ART

Liquid fuels for internal combustion engines contain components that can degrade during the functioning of the engine. The problem of deposits in the internal parts of combustion engines is well known to motorists. It has been shown that the formation of these deposits has consequences on the performance of the engine and in particular a negative impact on consumption and particle emissions. Progress in the technology of fuel additives has made it possible to face up to this problem. “Detergent” additives in fuels have already been proposed to keep the engine clean by limiting deposits (“keep-clean” effect) or by reducing the deposits already present in the internal parts of the combustion engine (“clean-up” effect). Mention may be made, for example, of U.S. Pat. No. 4,171,959 which describes a detergent additive for petrol fuel containing a quaternary ammonium function. WO 2006/135 881 describes a detergent additive containing a quaternary ammonium salt used for reducing or cleaning deposits, especially on the inlet valves. However, engine technology is in constant evolution and the stipulations for fuels must evolve to cope with these technological advances of combustion engines. In particular, the novel petrol or diesel direct-injection systems expose the injectors to increasingly severe pressure and temperature conditions, which promotes the formation of deposits. In addition, these novel injection systems have more complex geometries to optimize the spraying, especially, from more numerous holes having smaller diameters, but which, on the other hand, induce greater sensitivity to deposits. The presence of deposits may impair the combustion performance and in particular increase pollutant emissions and particle emissions. Other consequences of the excessive presence of deposits have been reported in the literature, such as the increase in fuel consumption and maneuverability problems.

Preventing and reducing deposits in these novel engines are essential for optimum functioning of modern engines. There is thus a need to propose detergent additives for fuel which promote optimum functioning of combustion engines, especially for novel engine technologies.

There is also a need for a universal detergent additive that is capable of acting on deposits irrespective of the technology of the engine and/or the nature of the fuel. SUBJECT OF THE INVENTION

The Applicant has discovered that the copolymers according to the invention have noteworthy properties as detergent additive in liquid fuels for internal combustion engines. The copolymers according to the invention used in these fuels can keep the engine clean, in particular by limiting or preventing the formation of deposits (“keep-clean” effect) or by reducing the deposits already present in the internal parts of the combustion engine (“clean-up” effect).

The advantages associated with the use of such copolymers according to the invention are:
optimum functioning of the engine,
reduction of the fuel consumption,
better maneuverability of the vehicle,
reduced pollutant emissions, and
savings due to less engine maintenance.

The subject of the present invention consequently relates to the use of a copolymer as detergent additive in a liquid fuel for internal combustion engines, said copolymer being obtained by copolymerization of at least:
an alkyl acrylate or alkyl methacrylate monomer (mₐ) and
a styrenyl monomer (m_{b}) chosen from styrene derivatives in which the aromatic nucleus is substituted with at least the group R or with at least one linear or branched C₁ to C₁₂ hydrocarbon-based chain, which is preferably acyclic, substituted with at least one group R, said group R being chosen from:
   a hydroxyl group,
   a group —OR′,
   a group —(OC_{y}H_{2y}O)_{f}—H,
   a group —(OC_{y}H_{2y}O)_{f}—R′,
   a group —O—(CO)—R′, and
   a group —(CO)—OR′,
y is an integer ranging from 2 to 8, f is an integer ranging from 1 to 10 and R′ is chosen from C₁ to C₂₄ alkyl chains.

In particular, the copolymer is a block copolymer comprising at least:
one block A consisting of a chain of structural units derived from an alkyl acrylate or alkyl methacrylate monomer (mₐ), and
one block B consisting of a chain of structural units derived from a styrenyl monomer (m_{b}).

The block copolymer advantageously comprises at least one sequence of blocks AB, ABA or BAB in which said blocks A and B form a sequence without the presence of an intermediate block of different chemical nature.

According to a particular development, the block copolymer is obtained by sequenced polymerization, optionally followed by one or more post-functionalizations.

Advantageously, the group R is chosen from:
a hydroxyl group, and
a group —O—(CO)—R′, R′ being chosen from C₁ to C₂₄ hydrocarbon-based chains.

The alkyl acrylate or alkyl methacrylate monomer (mₐ) is preferably chosen from C₁ to C₃₄ alkyl acrylates and methacrylates, said alkyl radical of the acrylate or methacrylate preferably being acyclic.

Advantageously, the styrenyl monomer (m_{b}) is chosen from styrene derivatives in which the aromatic nucleus is substituted with at least one group —O—(CO)—R′, R′ being chosen from C₁ to C₂₄ alkyls.

In particular, the styrenyl monomer (m_{b}) is chosen from styrene derivatives in which the aromatic nucleus is substituted with at least one hydroxyl group or with a linear or branched C₁ to C₁₂ hydrocarbon-based chain, which is preferably acyclic, substituted with at least one hydroxyl group.

The copolymer is preferably used in a liquid fuel chosen from hydrocarbon-based fuels and fuels that are not essentially hydrocarbon-based, alone or as a mixture.

In particular, the copolymer may be used in the form of a concentrate comprising an organic liquid that is inert with respect to the copolymer and miscible in the liquid fuel.

The copolymer is preferably used in the form of an additive concentrate in combination with at least one fuel additive for an internal combustion engine other than said copolymer.

Advantageously, the copolymer is used in the liquid fuel to keep clean and/or to clean-up at least one of the internal parts of an internal combustion engine.

The copolymer is preferably used in the liquid fuel to limit or prevent the formation of deposits in at least one of the internal parts of an internal combustion engine and/or to reduce the existing deposits in at least one of the internal parts of said engine.

The copolymer is preferably used to reduce the fuel consumption of an internal combustion engine, in particular to reduce the pollutant emissions.

According to a particular embodiment, the internal combustion engine is a spark ignition engine.

According to another particular embodiment, the internal combustion engine may be a diesel engine, preferably a direct-injection diesel engine. In this case, the copolymer may be used to limit or prevent and/or reduce coking-related deposits and/or deposits of soap and/or lacquering type.

In particular, in this case, the copolymer may be used to reduce and/or prevent power loss due to the formation of deposits in the internal parts of a direct-injection diesel engine, said power loss being determined according to the standardized engine test method CEC F-98-08.

The copolymer may also be used to reduce and/or prevent restriction of the fuel flow emitted by the injector of a direct-injection diesel engine during its functioning, said flow restriction being determined according to the standardized engine test method CEC F-23-1-01.

The subject of the present invention also relates to a process for keeping clean and/or for cleaning at least one of the internal parts of an internal combustion engine, comprising at least the following steps:
the preparation of a fuel composition by supplementation of a fuel with one or more block copolymers as described in any one of claims 1 to 8, and
combustion of said fuel composition in said internal combustion engine.

According to a particular embodiment, the internal combustion engine is a spark ignition engine.

In particular, the internal part of the spark ignition engine that is kept clean and/or cleaned is chosen from the engine intake system, the combustion chamber (CCD or TCD) and the fuel injection system.

According to another particular embodiment, the internal combustion engine is a diesel engine, preferably a direct-injection diesel engine.

In particular, the internal part of the diesel engine that is kept clean and/or cleaned is the injection system of the diesel engine.

### DETAILED DESCRIPTION

Other advantages and characteristics will emerge more clearly from the description that follows. The particular embodiments of the invention are given as non-limiting examples.

According to a particular embodiment, a copolymer is obtained by copolymerization of at least one alkyl acrylate or alkyl methacrylate monomer mₐ and of at least one styrenyl monomer m_{b}.

Monomer mₐ is chosen from C₁ to C₃₄, preferably C₄ to C₃₀, more preferentially C₆ to C₂₄ and more preferentially C₈ to C₂₂ alkyl acrylates and methacrylates. The alkyl radical of the acrylate or methacrylate is linear or branched, cyclic or acyclic, preferably acyclic.

Among the alkyl (meth)acrylates that may be used in the manufacture of the copolymer of the invention, mention may be made, in a non-limiting manner, of: n-octyl acrylate, n-octyl methacrylate, n-decyl acrylate, n-decyl methacrylate, n-dodecyl acrylate, n-dodecyl methacrylate, 2-ethylhexyl acrylate, 2-ethylhexyl methacrylate, isooctyl acrylate, isooctyl methacrylate, isodecyl acrylate, isodecyl methacrylate.

Monomer m_{b} is chosen from styrenyl derivatives in which the aromatic nucleus is substituted with at least one group R or with at least one linear or branched C₁ to C₁₂ and preferably C₁ to C₄ hydrocarbon-based chain, which is preferably acyclic, advantageously —CH₂—, substituted with at least the group R.

The term “hydrocarbon-based chain” means a chain constituted exclusively of carbon and hydrogen atoms, said chain possibly being linear or branched, cyclic, polycyclic or acyclic, saturated or unsaturated, and optionally aromatic or polyaromatic. A hydrocarbon-based chain may comprise a linear or branched part and a cyclic part. It may comprise an aliphatic part and an aromatic part.

The substitution on the aromatic nucleus of the styrenyl group is ortho, meta or para, preferably para.

Preferably, the aromatic nucleus of the styrenyl group is substituted with only one substituent.

The group R is chosen from:
a hydroxyl group,
alkoxy groups: —OR′, R′ representing a C₁ to C₂₄ and preferably C₁ to C₁₂ alkyl, and polyalkoxy groups: —(OC_{y}H_{2y}O)_{f}—H in which y is an integer ranging from 2 to 8, preferably from 2 to 4 and preferentially from 2 to 3, and f is an integer ranging from 1 to 10, preferably from 2 to 8 and more preferentially from 2 to 4,
alkyl carboxylates or alkyl esters: —(CO)—OR′, R′ representing a C₁ to C₂₄ and preferably C₁ to C₁₂ alkyl,
alkyl carboxylates or alkyl esters: —O—(CO)—R′, R′ representing a C₁ to C₂₄ and preferably C₁ to C₁₂ alkyl,

The group R is preferably chosen from:
a hydroxyl group,
alkoxy groups: —OR′, R′ representing a C₁ to C₂₄ and preferably C₁ to C₁₂ alkyl,
polyalkoxy groups: —(OC_{y}H_{2y}O)_{f}—H in which y is an integer ranging from 2 to 8, preferably from 2 to 4 and preferentially from 2 to 3, and f is an integer ranging from 1 to 10, preferably from 2 to 8 and more preferentially from 2 to 4,
polyalkoxy groups: —(OC_{y}H_{2y}O)_{f}—R′ in which y is an integer ranging from 2 to 8, preferably from 2 to 4 and preferentially from 2 to 3, and f is an integer ranging from 1 to 10, preferably from 2 to 8 and more preferentially from 2 to 4, R′ representing a C₁ to C₂₄ and preferably C₁ to C₁₂ alkyl,
alkyl carboxylates or alkyl esters: —(CO)—OR′, R′ representing a C₁ to C₂₄ and preferably C₁ to C₁₂ alkyl,
alkyl carboxylates or alkyl esters: —O—(CO)—R′, R′ representing a C₁ to C₂₄ and preferably C₁ to C₁₂ alkyl,

Even more preferentially, R is chosen from alkyl carboxylates: —O—(CO)—R′, R′ representing a C₁ to C₂₄ and preferably C₁ to C₁₂ alkyl.

The group R is preferably an acetoxy group.

According to a preferred embodiment, monomer m_{b} is chosen from styrene derivatives in which the aromatic nucleus is substituted with a group —CH₂—R.

According to this preferred embodiment, the group R is preferably chosen from
a hydroxyl group, and
alkyl carboxylates: —O—(CO)—R′, R′ representing a C₁ to C₂₄ and preferably C₁ to C₁₂ alkyl, more preferentially an acetoxy group.

According to this preferred embodiment, the group R is preferably chosen from
a hydroxyl group, and
an acetoxy group.

The styrenyl monomer m_{b} may be chosen in particular from styrene derivatives in which the aromatic nucleus is substituted with at least one alkyl carboxylate group —O—(CO)—R′, R′ representing a C₁ to C₂₄, preferably C₁ to C₁₂ and more preferentially C₁ to C₈ alkyl, even more preferentially an acetoxy group.

The alkyl carboxylate group —O—(CO)—R′ may be in the ortho, meta or para position on the aromatic nucleus, preferably in the para position.

According to a particular embodiment, the styrenyl monomer m_{b} is chosen from styrene derivatives in which the aromatic nucleus is substituted in the ortho, meta or para position with at least one hydroxyl group or with a linear or branched C₁ to C₁₂ and preferably C₁ to C₄ hydrocarbon-based chain, which is preferably acyclic, substituted with at least one hydroxyl group.

According to a particular embodiment, the styrenyl monomer m_{b} is represented by formula (I) below:

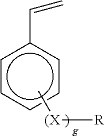

in which:
   g=0 or 1,
   X represents a C₁ to C₁₂ and preferably C₁ to C₄ hydrocarbon-based chain, more preferentially a —CH₂ group,
   R is as described above, in particular chosen from —OH, —OR′, —O—(CO)—R′ and —(CO)—OR′ with R′ being chosen from C₁ to C₂₄, preferably C₁ to C₁₂ and more preferentially C₁ to C₈ hydrocarbon-based chains.

The styrenyl monomer m_{b} is chosen, for example, from vinylphenols and vinylphenylmethanols in the ortho, meta and para position, preferably para.

The styrenyl monomer m_{b} is chosen, for example, from acetoxystyrene in the ortho, meta and para position, preferably para.

The copolymer may be prepared according to any known polymerization process. The various polymerization techniques and conditions are widely described in the literature and fall within the general knowledge of a person skilled in the art.

It is understood that it would not constitute a departure from the scope of the invention if the copolymer according to the invention were obtained from monomers other than mₐ and m_{b}, insofar as the final copolymer corresponds to that of the invention, i.e. obtained from at least mₐ and m_{b}. For example, it would not constitute a departure from the scope of the invention if the copolymer were obtained by copolymerization of monomers other than mₐ and m_{b} followed by a post-functionalization.

For example, the units derived from an alkyl (meth)acrylate monomer mₐ may be obtained from a polymethyl(meth)acrylate fragment, by transesterification reaction using an alcohol of chosen chain length to form the expected alkyl group.

For example, the units derived from a poly(alkyl styrenyl ester) monomer m_{b} may be obtained from a poly(vinylphenol) fragment by esterification reaction.

According to a particular embodiment, the copolymer is a block copolymer comprising at least:
one block A consisting of a chain of structural units derived from the alkyl acrylate or alkyl methacrylate monomer mₐ, and
one block B consisting of a chain of structural units derived from the styrenyl monomer m_{b}.

The block copolymer may be obtained by sequenced polymerization, preferably by controlled sequenced polymerization, optionally followed by one or more post-functionalizations.

According to a particular embodiment, the block copolymer described above is obtained by controlled sequenced polymerization. The polymerization is advantageously chosen from controlled radical polymerization; for example atom transfer radical polymerization (ATRP); nitroxide-mediated radical polymerization (NMP); degenerative transfer processes such as degenerative iodine transfer polymerization (ITRP: iodine transfer radical polymerization) or reversible addition-fragmentation chain transfer radical polymerization (RAFT); polymerizations derived from ATRP such as polymerizations using initiators for continuous activator regeneration (ICAR) or using activators regenerated by electron transfer (ARGET).

Mention will be made, by way of example, of the publication “Macromolecular engineering by atom transfer radical polymerization” JACS, 136, 6513-6533 (2014), which describes a controlled block polymerization process for forming block copolymers.

The controlled block polymerization is typically performed in a solvent, under an inert atmosphere, at a reaction temperature generally ranging from 0 to 200° C., preferably from 50° C. to 130° C. The solvent may be chosen from polar solvents, in particular ethers such as anisole (methoxybenzene) or tetrahydrofuran, or apolar solvents, in particular paraffins, cycloparaffins, aromatic and alkylaromatic solvents containing from 1 to 19 carbon atoms, for example benzene, toluene, cyclohexane, methylcyclohexane, n-butene, n-hexane, n-heptane and the like.

For atom-transfer radical polymerization (ATRP), the reaction is generally performed under vacuum in the presence of an initiator, a ligand and a catalyst. As examples of ligands, mention may be made of N,N,N′,N″,N″-pentamethyldiethylenetriamine (PMDETA), 1,1,4,7,10,10-hexamethyltriethylenetetramine (HMTETA), 2,2′-bipyridine (BPY) and tris(2-pyridylmethyl)amine (TPMA). Examples of catalysts that may be mentioned include: CuX, CuX₂, with X=Cl, Br and complexes based on ruthenium Ru²⁺/Ru³⁺.

The ATRP polymerization is preferably performed in a solvent chosen from polar solvents.

According to the controlled block polymerization technique, it may also be envisaged to work under pressure.

According to a particular embodiment, the number of equivalents of monomer mₐ in block A and of monomer m_{b} in block B reacted during the polymerization reaction are identical or different and have a value ranging independently from 2 to 40, preferably from 3 to 30, more preferentially from 4 to 20 and even more preferentially from 5 to 10. The term “number of equivalents” means the ratio between the amounts (in moles) of material of the monomers mₐ of block A and of the monomers m_{b} of block B during the polymerization reaction.

The number equivalents of monomer mₐ of block A is advantageously greater than or equal to that of the monomer m_{b} of block B. In addition, the weight-average molar mass M_{w} of block A or of block B is preferably less than or equal to 15 000 g·mol⁻¹, more preferentially less than or equal to 10 000 g·mol⁻¹.

The copolymer advantageously comprises at least one sequence of blocks AB, ABA or BAB in which said blocks A and B form a sequence without the presence of an intermediate block of different chemical nature.

Other blocks may optionally be present in the block copolymer described previously insofar as these blocks do not fundamentally change the nature of the block copolymer. However, block copolymers containing only blocks A and B will be preferred.

Advantageously, A and B represent at least 70% by mass, preferably at least 90% by mass, more preferentially at least 95% by mass and even more preferentially at least 99% by mass of the block copolymer.

According to a particular embodiment, the block copolymer is a diblock copolymer.

According to another particular embodiment, the block copolymer is a triblock copolymer containing alternating blocks comprising two blocks A and one block B (ABA) or comprising two blocks B and one block A (BAB).

According to a particular embodiment, the block copolymer also comprises an end chain I consisting of a cyclic or acyclic, saturated or unsaturated, linear or branched C₁ to C₃₂, preferably C₄ to C₂₄ and more preferentially C₁₀ to C₂₄ hydrocarbon-based chain.

The term “cyclic hydrocarbon-based chain” means a hydrocarbon-based chain of which at least part is cyclic, especially aromatic. This definition does not exclude hydrocarbon-based chains comprising both an acyclic part and a cyclic part.

The end chain I may comprise an aromatic hydrocarbon-based chain, for example benzene-based, and/or a saturated and acyclic, linear or branched hydrocarbon-based chain, in particular an alkyl chain.

The end chain I is preferably chosen from alkyl chains, which are preferably linear, more preferentially alkyl chains of at least 4 carbon atoms and even more preferentially of at least 12 carbon atoms.

For the ATRP polymerization, the end chain I is located in the end position of the block copolymer. It may be introduced into the block copolymer by means of the polymerization initiator. Thus, the end chain I may advantageously constitute at least part of the polymerization initiator and is positioned within the polymerization initiator so as to make it possible to introduce, during the first step of polymerization initiation, the end chain I in the end position of the block copolymer.

The polymerization initiator is chosen, for example, from the free-radical initiators used in the ATRP polymerization process. These free-radical initiators well known to those skilled in the art are described especially in the article “Atom-transfer radical polymerization: current status and future perspectives, Macromolecules, 45, 4015-4039, 2012”.

The polymerization initiator is chosen, for example, from carboxylic acid alkyl esters substituted with a halide, preferably a bromine in the alpha position, for example ethyl 2-bromopropionate, ethyl α-bromoisobutyrate, benzyl chloride or bromide, ethyl α-bromophenylacetate and chloroethylbenzene. Thus, for example, ethyl 2-bromopropionate may make it possible to introduce into the copolymer the end chain I in the form of a C₂ alkyl chain and benzyl bromide in the form of a benzyl group.

For the RAFT polymerization, the transfer agent may conventionally be removed from the copolymer at the end of polymerization according to any known process.

According to one variant, the end chain I may also be obtained in the copolymer by RAFT polymerization according to the methods described in the article by Moad, G. and co., Australian Journal of Chemistry, 2012, 65, 985-1076. The end chain I may, for example, be introduced by aminolysis when a transfer agent is used, in particular transfer agents of thiocarbonylthio, dithiocarbonate, xanthate, dithiocarbamate and trithiocarbonate type, for example S,S-bis(α,α′-dimethyl-α″-acetic acid) trithiocarbonate (BDMAT) or 2-cyano-2-propyl benzodithioate.

According to a particular embodiment, the block copolymer is a diblock copolymer. The block copolymer structure may be of the IAB or IBA type, advantageously IAB. The end chain I may be directly linked to block A or B according to the structure IAB or IBA, respectively, or may be connected via a bonding group, for example an ester, amide, amine or ether function. The bonding group then forms a bridge between the end chain I and block A or B.

According to a particular embodiment, the block copolymer may also be functionalized at the chain end according to any known process, especially by hydrolysis, aminolysis and/or nucleophilic substitution.

The term “aminolysis” means any chemical reaction in which a molecule is split into two parts by reaction of an ammonia molecule with an amine. A general example of aminolysis consists in replacing a halogen of an alkyl group by reaction with an amine, with removal of hydrogen halide. Aminolysis may be used, for example, for an ATRP polymerization which produces a copolymer bearing a halide in the end position or for a RAFT polymerization to remove the thio, dithio or trithio bond introduced into the copolymer by the RAFT transfer agent.

An end chain I′ may thus be introduced by post-functionalization of the block copolymer obtained by controlled block polymerization of the monomers mₐ and m_{b} described above.

The end chain I′ advantageously comprises a linear or branched, cyclic or acyclic C₁ to C₃₂, preferably C₁ to C₂₄ and more preferentially C₁ to C₁₀ hydrocarbon-based chain, even more preferentially and alkyl group, optionally substituted with one or more groups containing at least one heteroatom chosen from N and O, preferably N.

For an ATRP polymerization using a metal halide as catalyst, this functionalization may be performed, for example, by treating the copolymer IAB or IBA obtained by ATRP with a primary C₁ to C₃₂ alkylamine or a C₁ to C₃₂ alcohol under mild conditions so as not to modify the functions present on blocks A, B and I.

According to a preferred particular embodiment, the block copolymer is represented by one of the formulae (II) and (III) below:

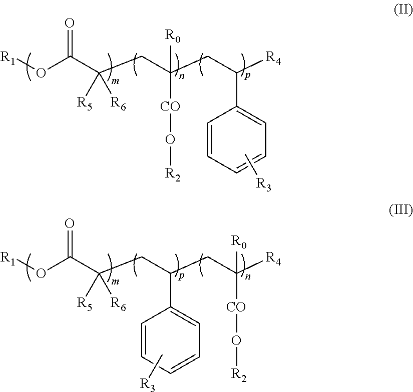

in which
m=0 or 1,
n is an integer ranging from 2 to 40, preferably from 3 to 30, more preferentially from 4 to 20, even more preferentially from 5 to 10,
p is an integer ranging from 2 to 40, preferably from 3 to 30, more preferentially from 4 to 20, even more preferentially from 5 to 10,
R₀ is chosen from hydrogen and a methyl group,
R₁ is chosen from cyclic or acyclic, saturated or unsaturated, linear or branched C₁ to C₃₂, preferably C₄ to C₂₄ and more preferentially C₁₀ to C₂₄ hydrocarbon-based chains, preferably alkyl groups, and groups derived from a reversible addition-fragmentation chain-transfer (RAFT) radical polymerization transfer agent, it being understood that if R₁ is a group derived from a transfer agent, then m=0.

RAFT-type transfer agents are well known to those skilled in the art. A wide variety of RAFT-type transfer agents are available or are fairly readily synthesizable. Examples that may be mentioned include transfer agents of thiocarbonylthio, dithiocarbonate, xanthate, dithiocarbamate and trithiocarbonate type, for example S,S-bis(α,α′-dimethyl-α″-acetic acid) trithiocarbonate (BDMAT) or 2-cyano-2-propyl benzodithioate.

R₂ is chosen from linear or branched, cyclic or acyclic, preferably acyclic, C₁ to C₃₄, preferably C₄ to C₃₀, more preferentially C₆ to C₂₄ and even more preferentially C₈ to C₂₄ alkyl groups,

R₃ is a substituent in the ortho, meta or para position on the aromatic nucleus, preferably in the para position, chosen from the group constituted by:
a hydroxyl or —CH₂OH group,
C₁ to C₂₄ and preferably C₁ to C₁₂ alkoxy groups,
polyalkoxy groups: —(OC_{y}H_{2y}O)_{f}—H in which y is an integer ranging from 2 to 8, preferably from 2 to 4 and more preferentially from 2 to 3, and f is an integer ranging from 1 to 10, preferably from 2 to 8 and more preferentially from 2 to 4,
polyalkoxy groups: —(OC_{y}H_{2y}O)_{f}—R₈ in which y is an integer ranging from 2 to 8, preferably from 2 to 4 and more preferentially from 2 to 3, and f is an integer ranging from 1 to 10, preferably from 2 to 8 and more preferentially from 2 to 4, and R₈ represents a C₁ to C₂₄ and preferably C₁ to C₁₂ alkyl,
groups —OCOR₇ and —COOR₇ in which R₇ is chosen from linear or branched C₁ to C₂₄, preferably C₁ to C₁₂ and more preferentially C₁ to C₆ alkyl groups, which are preferably acyclic, and

R₄ is chosen from the group constituted by:
hydrogen;
—OH;
halogens, preferably bromine; and
cyclic or acyclic, saturated or unsaturated, linear or branched C₁ to C₃₂, preferably C₁ to C₂₄ and more preferentially C₁ to C₁₀ hydrocarbon-based chains, preferably alkyl groups, said chains being optionally substituted with one or more groups containing at least one heteroatom chosen from N and O,

R₅ and R₆ are identical or different and chosen independently from the group constituted by hydrogen and linear or branched, more preferentially acyclic, C₁ to C₁₀ and preferably C₁ to C₄ alkyl groups, even more preferentially a methyl group.

R₁ is preferably chosen from cyclic or acyclic, saturated or unsaturated, linear or branched C₁ to C₃₂, preferably C₄ to C₂₄ and more preferentially C₁₀ to C₂₄ alkyl groups.

R₃ is a substituent in the ortho, meta or para position on the aromatic nucleus, preferably in the para position, chosen from groups —OCOR₇ in which R₇ is as described above.

In formulae (II) and (III), block A corresponds to the unit repeated n times and block B to the unit repeated p times. In addition, the group R₁ may be constituted of the end chain I as described above and/or the group R₄ may be constituted of the end chain I′ as described above.

The copolymer described above is particularly advantageous when it is used as detergent additive in a liquid fuel for an internal combustion engine.

The term “detergent additive for liquid fuel” means an additive which is incorporated in small amount into the liquid fuel and produces an effect on the cleanliness of said motor when compared with said liquid fuel not specially supplemented with additive.

The liquid fuel is advantageously derived from one or more sources chosen from the group consisting of mineral, animal, plant and synthetic sources. Crude oil will preferably be chosen as mineral source.

The liquid fuel is preferably chosen from hydrocarbon-based fuels and fuels that are not essentially hydrocarbon-based, alone or as a mixture.

The term “hydrocarbon-based fuel” means a fuel constituted of one or more compounds constituted solely of carbon and hydrogen.

The term “fuel not essentially hydrocarbon-based” means a fuel constituted of one or more compounds not essentially constituted of carbon and hydrogen, i.e. which also contain other atoms, in particular oxygen atoms.

The hydrocarbon-based fuels especially comprise middle distillates with a boiling point ranging from 100 to 500° C. or lighter distillates with a boiling point in the gasoline range. These distillates may be chosen, for example, from the distillates obtained by direct distillation of crude hydrocarbons, vacuum distillates, hydrotreated distillates, distillates derived from the catalytic cracking and/or hydrocracking of vacuum distillates, distillates resulting from conversion processes such as ARDS (atmospheric residue desulfurization) and/or viscoreduction, and distillates derived from the upgrading of Fischer-Tropsch fractions. The hydrocarbon-based fuels are typically gasolines and gas oils (also known as diesel fuel).

The gasolines in particular comprise any commercially available fuel composition for spark ignition engines. A representative example that may be mentioned is the gasolines corresponding to standard NF EN 228. Gasolines generally have octane numbers that are high enough to avoid pinking. Typically, the fuels of gasoline type sold in Europe, in accordance with standard NF EN 228, have a motor octane number (MON) of greater than 85 and a research octane number (RON) of at least 95. Fuels of gasoline type generally have an RON ranging from 90 to 100 and an MON ranging from 80 to 90, the RON and MON being measured according to standard ASTM D 2699-86 or D 2700-86.

Gas oils (diesel fuels) in particular comprise all commercially available fuel compositions for diesel engines. A representative example that may be mentioned is the gas oils corresponding to standard NF EN 590.

Fuels that are not essentially hydrocarbon-based especially comprise oxygen-based compounds, for example distillates resulting from the BTL (biomass to liquid) conversion of plant and/or animal biomass, taken alone or in combination; biofuels, for example plant and/or animal oils and/or ester oils; biodiesels of animal and/or plant origin and bioethanols.

The mixtures of hydrocarbon-based fuel and of fuel that is not essentially hydrocarbon-based are typically gas oils of Bₓ type or gasolines of Eₓ type.

The term “gas oil of Bₓ type for diesel engines” means a gas oil fuel which contains x % (v/v) of plant or animal ester oils (including spent cooking oils) transformed via a chemical process known as transesterification, obtained by reacting this oil with an alcohol so as to obtain fatty acid esters (FAE). With methanol and ethanol, fatty acid methyl esters (FAME) and fatty acid ethyl esters (FAEE) are obtained, respectively. The letter “B” followed by a number indicates the percentage of FAE contained in the gas oil. Thus, a B99 contains 99% of FAE and 1% of middle distillates of fossil origin (mineral source), B20 contains 20% of FAE and 80% of middle distillates of fossil origin, etc. Gas oils of B₀ type which do not contain any oxygen-based compounds are thus distinguished from gas oils of Bx type which contain x % (v/v) of plant oil esters or of fatty acid esters, usually the methyl esters (POME or FAME). When the FAE is used alone in engines, the fuel is designated by the term B100.

The term “gasoline of Eₓ type for spark ignition engines” means a gasoline fuel which contains x % (v/v) of oxygen-based compounds, generally ethanol, bioethanol and/or tert-butyl ethyl ether (TBEE).

The sulfur content of the liquid fuel is preferably less than or equal to 5000 ppm, preferably less than or equal to 500 ppm and more preferentially less than or equal to 50 ppm, or even less than or equal to 10 ppm and advantageously sulfur-free.

The copolymer described above is used as detergent additive in the liquid fuel in a content advantageously of at least 10 ppm, preferably at least 50 ppm, more preferentially in a content ranging from 10 to 5000 ppm, even more preferentially from 10 to 1000 ppm.

According to a particular embodiment, the use of a copolymer as described previously in the liquid fuel makes it possible to maintain the cleanliness of at least one of the internal parts of the internal combustion engine and/or to clean-up at least one of the internal parts of the internal combustion engine.

The use of the copolymer in the liquid fuel makes it possible in particular to limit or prevent the formation of deposits in at least one of the internal parts of said engine (“keep-clean” effect) and/or to reduce the existing deposits in at least one of the internal parts of said engine (“clean-up” effect).

Thus, the use of the copolymer in the liquid fuel makes it possible, when compared with liquid fuel that is not specially supplemented, to limit or prevent the formation of deposits in at least one of the internal parts of said engine or to reduce the existing deposits in at least one of the internal parts of said engine.

Advantageously, the use of the copolymer in the liquid fuel makes it possible to observe both effects simultaneously, limitation (or prevention) and reduction of deposits (“keep-clean” and “clean-up” effects).

The deposits are distinguished as a function of the type of internal combustion engine and of the location of the deposits in the internal parts of said engine.

According to a particular embodiment, the internal combustion engine is a spark ignition engine, preferably with direct injection (DISI: direct-injection spark ignition engine). The deposits targeted are located in at least one of the internal parts of said spark ignition engine. The internal part of the spark ignition engine kept clean and/or cleaned up is advantageously chosen from the engine intake system, in particular the intake valves (IVD: intake valve deposit), the combustion chamber (CCD: combustion chamber deposit, or TCD: total chamber deposit) and the fuel injection system, in particular the injectors of an indirect injection system (PFI: port fuel injector) or the injectors of a direct injection system (DISI).

According to another particular embodiment, the internal combustion engine is a diesel engine, preferably a direct-injection diesel engine, in particular a diesel engine with a common-rail injection system (CRDI: common-rail direct injection). The deposits targeted are located in at least one of the internal parts of said diesel engine.

Advantageously, the deposits targeted are located in the injection system of the diesel engine, preferably located on an external part of an injector of said injection system, for example the fuel spray tip and/or on an internal part of an injector of said injection system (IDID: internal diesel injector deposits), for example on the surface of an injector needle.

The deposits may be constituted of coking-related deposits and/or deposits of soap or lacquering type.

The copolymer as described previously may advantageously be used in the liquid fuel to reduce and/or prevent power loss due to the formation of said deposits in the internal parts of a direct-injection diesel engine, said power loss being determined according to the standardized engine test method CEC F-98-08.

The copolymer as described previously may advantageously be used in the liquid fuel to reduce and/or prevent restriction of the fuel flow emitted by the injector of a direct-injection diesel engine during its functioning, said flow restriction being determined according to the standardized engine test method CEC F-23-1-01.

Advantageously, the use of the copolymer as described above makes it possible, when compared with liquid fuel that is not specially supplemented, to limit or prevent the formation of deposits on at least one type of deposit described previously and/or to reduce the existing deposits on at least one type of deposit described previously.

According to a particular embodiment, the use of the copolymer described above also makes it possible to reduce the fuel consumption of an internal combustion engine.

According to another particular embodiment, the use of the copolymer described above also makes it possible to reduce the pollutant emissions, in particular the particle emissions of an internal combustion engine.

Advantageously, the use of the copolymer makes it possible to reduce both the fuel consumption and the pollutant emissions.

The copolymer described above may be used alone, in the form of a mixture of at least two of said copolymers or in the form of a concentrate.

The copolymer may be added to the liquid fuel in a refinery and/or may be incorporated downstream of the refinery and/or optionally as a mixture with other additives in the form of an additive concentrate, also known by the common name “additive package”.

The concentrate described above comprises an organic liquid which is inert with respect to the copolymer described above and miscible in the liquid fuel described previously. The term “miscible” describes the fact that the copolymer and the organic liquid form a solution or a dispersion so as to facilitate the mixing of the copolymer in the liquid fuels according to the standard fuel supplementation processes.

The organic liquid is advantageously chosen from aromatic hydrocarbon-based solvents such as the solvent sold under the name Solvesso, alcohols, ethers and other oxygen-based compounds and paraffinic solvents such as hexane, pentane or isoparaffins, alone or as a mixture.

The concentrate may advantageously comprise from 5% to 99% by mass, preferably from 10% to 80% and more preferentially from 25% to 70% of copolymer as described previously.

The concentrate may typically comprise from 1% to 95% by mass, preferably from 10% to 70% and more preferentially from 25% to 60% of organic liquid, the remainder corresponding to the copolymer, it being understood that the concentrate may comprise one or more copolymers as described above.

In general, the solubility of the copolymer in the organic liquids and the liquid fuels described previously will depend especially on the weight-average and number-average molar masses M_{w} and Mₙ, respectively, of the copolymer. The average molar masses M_{w} and Mₙ of the copolymer will be chosen so that the copolymer is soluble in the liquid fuel and/or the organic liquid of the concentrate for which it is intended.

The average molar masses M_{w} and Mₙ of the copolymer may also have an influence on the efficiency of this copolymer as a detergent additive. The average molar masses M_{w} and Mₙ will thus be chosen so as to optimize the effect of the copolymer, especially the detergency effect (engine cleanliness) in the liquid fuels described above.

Optimizing the average molar masses M_{w} and Mₙ may be performed via routine tests accessible to those skilled in the art.

According to a particular embodiment, the copolymer advantageously has a weight-average molar mass (Mw) ranging from 500 to 30 000 g·mol⁻¹, preferably from 1000 to 10 000 g·mol⁻¹, more preferentially less than or equal to 4000 g·mol⁻¹, and/or a number-average molar mass (Mn) ranging from 500 to 15 000 g·mol⁻¹, preferably from 1000 to 10 000 g·mol⁻¹, more preferentially less than or equal to 4000 g·mol⁻¹. The number-average and weight-average molar masses are measured by size exclusion chromatography (SEC). The operating conditions of SEC, especially the choice of the solvent, will be chosen as a function of the chemical functions present in the copolymer.

According to a particular embodiment, the copolymer is used in the form of an additive concentrate in combination with at least one other fuel additive for an internal combustion engine other than the copolymer described previously.

The additive concentrate may typically comprise one or more other additives chosen from detergent additives other than the copolymer described above, for example from anticorrosion agents, dispersants, demulsifiers, antifoams, biocides, reodorants, proketane additives, friction modifiers, lubricant additives or oiliness additives, combustion promoters (catalytic combustion and soot promoters), agents for improving the cloud point, the flow point or the FLT (filterability limit temperature), anti-sedimentation agents, anti-wear agents and conductivity modifiers.

Among these additives, mention may be made in particular of:
a) proketane additives, especially (but not limitingly) chosen from alkyl nitrates, preferably 2-ethylhexyl nitrate, aryl or peroxides, preferably benzyl peroxide, and alkyl peroxides, preferably tert-butyl peroxide;
b) antifoam additives, especially (but not limitingly) chosen from polysiloxanes, oxyalkylated polysiloxanes and fatty acid amides derived from plants or animal oils. Examples of such additives are given in EP861882, EP663000 and EP736590;
c) cold flow improvers (CFI) chosen from copolymers of ethylene and of an unsaturated ester, such as ethylene/vinyl acetate (EVA), ethylene/vinyl propionate (EVP), ethylene/vinyl ethanoate (EVE), ethylene/methyl methacrylate (EMMA) and ethylene/alkyl fumarate copolymers described, for example, in U.S. Pat. No. 3,048,479, U.S. Pat. No. 3,627,838, U.S. Pat. No. 3,790,359, U.S. Pat. No. 3,961,961 and EP261957.
d) lubricant additives or anti-wear agents, especially (but not limitingly) chosen from the group constituted by fatty acids and ester or amide derivatives thereof, especially glyceryl monooleate, and monocyclic and polycyclic carboxylic acid derivatives. Examples of such additives are given in the following documents: EP680506, EP860494, WO98/04656, EP915944, FR2772783, FR2772784.
e) cloud point additives, especially (but not limitingly) chosen from the group constituted by long-chain olefin/(meth)acrylic ester/maleimide terpolymers, and fumaric/maleic acid ester polymers. Examples of such additives are given in FR2528051, FR2528051, FR2528423, EP112195, EP172758, EP271385 and EP291367;
f) detergent additives, especially (but not limitingly) chosen from the group constituted by succinimides, polyetheramines and quaternary ammonium salts; for example those described in U.S. Pat. No. 4,171,959 and WO2006135881.
g) cold workability polyfunctional additives chosen from the group constituted by polymers based on olefin and alkenyl nitrate as described in EP573490.

These other additives are generally added in an amount ranging from 100 to 1000 ppm (each).

The mole ratio and/or mass ratio between monomer m_{b} and monomer mₐ and/or between block A and B in the block copolymer described above will be chosen so that the copolymer is soluble in the fuel and/or the organic liquid of the concentrate for which it is intended. Similarly, this ratio may be optimized as a function of the fuel and/or of the organic liquid so as to obtain the best effect on the engine cleanliness.

Optimizing the mole ratio and/or mass ratio may be performed via routine tests accessible to those skilled in the art.

The mole ratio between monomer m_{b} and monomer mₐ or between blocks A and B in the block copolymer described above advantageously ranges from 1:10 to 10:1, preferably from 1:2 to 2:1 and more preferentially from 1:0.5 to 0.5:2.

According to a particular embodiment, a fuel composition is prepared according to any known process by supplementing the liquid fuel described previously with at least one copolymer as described above.

The combustion of this fuel composition comprising such a copolymer in an internal combustion engine produces an effect on the cleanliness of the engine when compared with the liquid fuel not specially supplemented and makes it possible in particular to prevent or reduce the fouling of the internal parts of said engine. The effect on the cleanliness of the engine is as described previously in the context of using the copolymer.

According to a particular embodiment, combustion of the fuel composition comprising such a copolymer in an internal combustion engine also makes it possible to reduce the fuel consumption and/or the pollutant emissions.

The copolymer is preferably incorporated in small amount into the liquid fuel described previously, the amount of copolymer being sufficient to produce a detergent effect as described above and thus to improve the engine cleanliness.

The fuel composition advantageously comprises at least 10 ppm, preferably at least 50 ppm, advantageously from 10 to 5000 ppm and more preferentially from 10 to 1000 ppm of the copolymer described above.

Besides the copolymer described above, the fuel composition may also comprise one or more other additives other than the copolymer according to the invention, chosen from the other known detergent additives, for example from anticorrosion agents, dispersants, demulsifiers, antifoams, biocides, reodorants, proketane additives, friction modifiers, lubricant additives or oiliness additives, combustion promoters (catalytic combustion and soot promoters), agents for improving the cloud point, the flow point or the FLT, anti-sedimentation agents, anti-wear agents and/or conductivity modifiers.

The additives different from the copolymer according to the invention are, for example, the fuel additives listed above.

According to a preferred particular embodiment, the copolymer is a block copolymer as described above.

According to a particular embodiment, a process for keeping clean (“keep-clean” effect) and/or for cleaning (“clean-up” effect) at least one of the internal parts of an internal combustion engine comprises at least the following steps:
the preparation of a fuel composition by supplementation of a fuel with one or more copolymers as described above, and
combustion of said fuel composition in the internal combustion engine.

According to a particular embodiment, the internal combustion engine is a spark ignition engine, preferably with direct injection (DISI).

The internal part of the spark ignition engine that is kept clean and/or cleaned is preferably chosen from the engine intake system, in particular the intake valves (IVD), the combustion chamber (CCD or TCD) and the fuel injection system, in particular the injectors of an indirect injection system (PFI) or the injectors of a direct injection system (DISI).

According to another particular embodiment, the internal combustion engine is a diesel engine, preferably a direct-injection diesel engine, in particular a diesel engine with a common-rail injection system (CRDI).

The internal part of the diesel engine that is kept clean and/or cleaned is preferably the injection system of the diesel engine, preferably an external part of an injector of said injection system, for example the fuel spray tip and/or one of the internal parts of an injector of said injection system, for example the surface of an injector needle.

The process for maintaining the cleanliness and/or for cleaning comprises the successive steps of:
a) determination of the most suitable supplementation for the fuel, said supplementation corresponding to the selection of the copolymer(s) described above to be incorporated in combination, optionally, with other fuel additives as described previously and the determination of the degree of treatment necessary to achieve a given specification relative to the detergency of the fuel composition.
b) incorporation into the fuel of the selected copolymer(s) in the amount determined in step a) and, optionally, of the other fuel additives.

The copolymer(s) may be incorporated into the fuel, alone or as a mixture, successively or simultaneously.

Alternatively, the copolymer(s) may be used in the form of a concentrate or of an additive concentrate as described above.

Step a) is performed according to any known process and falls within the common practice in the field of fuel supplementation. This step involves defining at least one representative characteristic of the detergency properties of the fuel composition.

The representative characteristic of the detergency properties of the fuel will depend on the type of internal combustion engine, for example a diesel or spark ignition engine, the direct or indirect injection system and the location in the engine of the deposits targeted for cleaning and/or maintaining the cleanliness.

For direct-injection diesel engines, the representative characteristic of the detergency properties of the fuel may correspond, for example, to the power loss due to the formation of deposits in the injectors or restriction of the fuel flow emitted by the injector during the functioning of said engine.

The representative characteristic of the detergency properties may also correspond to the appearance of lacquering-type deposits on the injector needle (IDID).

Other methods for evaluating the detergency properties of fuels have been widely described in the literature and fall within the general knowledge of a person skilled in the art. Non-limiting examples that will be mentioned include the tests standardized or acknowledged by the profession or the following methods described in the literature:

For direct-injection diesel engines:
the method DW10, standardized engine test method CEC F-98-08, for measuring the power loss of direct-injection diesel engines
The method XUD9, standardized engine test method CEC F-23-1-01 Issue 5 for measuring the restriction of fuel flow emitted by the injector
the method described by the Applicant in patent application WO 2014/029770, pages 17 to 20, for the evaluation of lacquering deposits (IDID), this method being cited by way of example and or incorporated by reference into the present patent application.

For indirect-injection spark ignition engines:
the Mercedes Benz M102E method, standardized test method CEC F-05-A-93, and
the Mercedes Benz M111 method, standardized test method CEC F-20-A-98.

These methods make it possible to measure the intake valve deposits (IVD), the tests generally being performed on a Eurosuper gasoline corresponding to standard EN228.

For direct-injection spark ignition engines:
the method described by the Applicant in the article “Evaluating Injector Fouling in Direct Injection Spark Ignition Engines”, Mathieu Arondel, Philippe China, Julien Gueit; Conventional and future energy for automobiles; 10th international colloquium; Jan. 20-22, 2015, pages 375-386 (Technische Akademie Esslingen par Techn. Akad. Esslingen, Ostfildern), for the evaluation of the coking deposits on the injector, this method being cited by way of example and/or incorporated by reference into the present patent application.
the method described in US20130104826 for the evaluation of the coking deposits on the injector, this method being cited by way of example and or incorporated by reference into the present patent application.

The determination of the amount of copolymer to be added to the fuel composition to achieve the specification (step a) (described previously) will typically be performed by comparison with the fuel composition not containing the copolymer according to the invention, the specification given relative to the detergency possibly being, for example, a target power loss value according to the method DW10 or a flow restriction value according to the method XUD9 mentioned above.

The amount of copolymer may also vary as a function of the nature and origin of the fuel, in particular as a function of the content of compounds bearing n-alkyl, isoalkyl or n-alkenyl substituents. The nature and origin of the fuel may also be a factor to be taken into consideration for step a).

The process for maintaining the cleanliness and/or for cleaning may also comprise an additional step after step b) of checking the target reached and/or of adjusting the level of supplementation with the copolymer(s) as detergent additive.

### Examples

Synthesis of Block Copolymers of Formula (II) or (III) by Atom-Transfer Radical Polymerization (ATRP).

Starting Materials:
Monomer mₐ: octadecyl acrylate (CAS 4813-57-4) or dodecyl acrylate (CAS 2156-97-0),
Monomer m_{b}: 4-acetoxystyrene (CAS 2628-16-2),
Initiator I: ethyl 2-bromopropionate (CAS 535-11-5) or octadecyl 2-bromopropionate,
Catalyst: copper bromide (CAS 7787-70-4),
Ligand: 1,1,4,7,10,10-hexamethyltriethylenetetramine (CAS 3083-10-1).

Nomenclature

For the nomenclature of the copolymers, use will be made of the letter A for the acrylate block with, as a subscript, the value of n, and, as a superscript, the number of carbon atoms in the chain R₂.

For the styrene block, use will be made of the letter B with, as a subscript, the value of p, and, as a superscript, “ac” indicating that the block is derived from acetoxystyrene.

For the end chain, use will be made of the letter I with the carbon number of the chain R₁ as a subscript.

The letters b- and s- before each name indicate the fact that the copolymer is, respectively, a block or statistical copolymer.

### Synthesis of octadecyl 2-bromopropionate

12 g of octadecanol (44 mmol, 1 eq) and 7.4 g of triethylamine (53 mmol, 1.2 eq) are dissolved in 110 mL of cryodistilled THF. 5.81 mL of 2-bromopropionyl bromide (55 mmol, 1.25 eq) are dissolved in 10 mL of cryodistilled THF. At 0° C., the 2-bromopropionyl bromide solution is added dropwise to the octadecanol solution. The solution is placed under magnetic stirring at 0° C. for 2 hours and then at room temperature for 12 hours. The THF is evaporated off on a rotary evaporator and the octadecyl 2-bromopropionate is dissolved in 100 mL of dichloromethane. The organic phase is washed twice with aqueous 10% hydrochloric acid solution, three times with water, twice with aqueous 1M sodium hydroxide solution and then three times with water. The organic phase is dried with sodium sulfate. The solvent is evaporated off on a rotary evaporator and the octadecyl 2-bromopropionate is then dried under vacuum. Mass yield=98%.

¹H NMR (400 MHz, 293 K, ppm in CDCl₃): δ 4.35 (q, 1H, e), 4.15 (m, 2H, d), 1.80 (d, 3H, f), 1.65 (tt, 2H, c), 1.24 (m, 30H, b), 0.87 (t, 3H, a).

### Example 1: Synthesis of a Dodecyl Acrylate/4-acetoxystyrene Block Copolymer

### IAB

A solution of initiator I is prepared by dissolving 1 equivalent of octadecyl 2-bromopropionate (1 g, 405 g·mol⁻¹) in 4 mL of anisole. The solution is degassed by sparging with nitrogen before use.
A monomer mₐ/catalyst/ligand solution is obtained by dissolving in 8 mL of anisole 7 equivalents of dodecyl acrylate (4.15 g, 240 g·mol⁻¹), 0.4 equivalent of copper bromide (142 mg, 143 g·mol⁻¹) and 0.4 equivalent of 1,1,4,7,10,10-hexamethyltriethylenetetramine (227 mg, 230 g·mol⁻¹), and the solution thus obtained is then degassed by sparging with nitrogen.
A monomer m_{b}/catalyst/ligand solution is obtained by dissolving in 4 mL of anisole 14 equivalents of 4-acetoxystyrene (5.61 g, 162 g·mol⁻¹), 0.4 equivalent of copper bromide (142 mg, 143 g·mol⁻¹) and 0.4 equivalent of 1,1,4,7,10,10-hexamethyltriethylenetetramine (227 mg, 230 g·mol⁻¹). The initiator solution is added under a stream of nitrogen to the monomer mₐ/catalyst/ligand solution. The mixture is placed under vacuum, with magnetic stirring, at 90° C., protected from light. The reaction progress is monitored by ¹H NMR spectroscopy (Brüker 400 MHz spectrometer). After 10 hours of reaction, all of the dodecyl acrylate is consumed. After degassing by sparging with nitrogen, the monomer m_{b}/catalyst/ligand solution is then added to the reaction medium. After 18 hours, 97% of the 4-acetoxystyrene is consumed. After 18 hours at 90° C., the reaction is quenched by plunging the flask into liquid nitrogen. 100 mL of tetrahydrofuran are added to the reaction medium and the solution thus obtained is then passed through a basic alumina column. The solvent is evaporated off on a rotary evaporator; 8.1 g (mass yield of 76%) of the block copolymer b-I₁₈A¹²₇B^{ac}₁₃ are obtained after precipitation from 400 mL of cold methanol, centrifugation and drying under vacuum.

¹H NMR (400 MHz, 293 K, ppm in CDCl₃): δ 6.3-7.0 (m, Ar), 4.05 (m, 3+7), 2.2 (m, g), 1.3-1.8 (m, c+d+4+8) 1.0-1.3 (m, 5+9), 0.8 (t, 6+10).

### Example 2: Synthesis of a 4-acetoxystyrene/Octadecyl Acrylate Block Copolymer IBA

Another block copolymer b-I₁₈B^{ac}₁₄A¹⁸₇ was synthesized according to the same protocol as example 1, except that the solution of initiator I is added under a stream of nitrogen to the monomer mₐ/catalyst/ligand solution instead of the monomer m_{b}/catalyst/ligand. After 5 hours of reaction, all of the 4-acetoxystyrene is consumed. After degassing by sparging with nitrogen, the monomer m_{b}/catalyst/ligand solution is then added to the reaction medium. After 28 hours, all of the octadecyl acrylate is consumed. After 28 hours at 90° C., the reaction is quenched by plunging the flask into liquid nitrogen. 100 mL of tetrahydrofuran are added to the reaction medium and the solution thus obtained is then passed through a basic alumina column. The solvent is evaporated off on a rotary evaporator; 9 g (mass yield of 72%) of the block copolymer b-I₁₈B^{ac}₁₄A¹⁸₇ are obtained after precipitation from 250 mL of cold methanol, centrifugation and drying under vacuum.

¹H NMR (400 MHz, 293 K, ppm in CDCl₃): δ 6.3-7.0 (m, Ar), 3.9 (m, d), 2.2 (s, g), 1.3-1.8 (m, c) 1.2 (m, b), 0.8 (t, a).

Other block copolymers of formula (II) or (III) described previously were synthesized according to the same protocol as example 1 or 2, but varying the nature of the monomers mₐ and m_{b} and of the initiator I, and also the ratio thereof. The characteristics of the block copolymers obtained are collated in table 1 below:

TABLE 1

| | (II)/ | | | | | | | | | | | | Mₙ⁽³⁾ | Yield ⁽⁴⁾ |
|---|---|---|---|---|---|---|---|---|---|---|---|---|---|---|
| Ref. ⁽¹⁾ | (III) | m | n | p | R₀ | R₁ | R₂ | R₃ | R₄ ⁽²⁾ | R₅ | R₆ | R₇ | g · mol⁻¹ | (%) |
| b-I₁₈A¹²₇B^{ac}₁₃ | (II) | 1 | 7 | 13 | H | —C₁₈H₃₇ | —C₁₂H₂₅ | —OCOR₇ | Br | —CH₃ | H | —CH₃ | 6000 | 76 |
| b-I₁₈A¹²₁₁B^{ac}₁₂ | (II) | 1 | 11 | 12 | H | —C₁₈H₃₇ | —C₁₂H₂₅ | —OCOR₇ | Br | —CH₃ | H | —CH₃ | 7700 | 78 |
| b-I₁₈A¹²₃B^{ac}₁₃ | (II) | 1 | 3 | 13 | H | —C₁₈H₃₇ | —C₁₂H₂₅ | —OCOR₇ | Br | —CH₃ | H | —CH₃ | 4800 | 79 |
| b-I₁₈A¹⁸₇B^{ac}₁₄ | (II) | 1 | 7 | 14 | H | —C₁₈H₃₇ | —C₁₈H₃₇ | —OCOR₇ | Br | —CH₃ | H | —CH₃ | 7400 | 81 |
| b-I₁₈ B^{ac}₁₄A¹⁸₇ | (III) | 1 | 7 | 14 | H | —C₁₈H₃₇ | —C₁₈H₃₇ | —OCOR₇ | Br | —CH₃ | H | —CH₃ | 8800 | 72 |
| b-I₂A¹²₇B^{ac}₁₃ | (II) | 1 | 7 | 13 | H | —C₂H₅ | —C₁₂H₂₅ | —OCOR₇ | Br | —CH₃ | H | —CH₃ | 6500 | 71 |
| b-I₂ B^{ac}₁₄A¹²₇ | (III) | 1 | 7 | 14 | H | —C₂H₅ | —C₁₂H₂₅ | —OCOR₇ | Br | —CH₃ | H | —CH₃ | 5800 | 57 |

⁽¹⁾ The values of m, n and p are determined by ¹H NMR spectroscopy (Brüker 400 MHz spectrometer).
⁽²⁾ There may be mixtures of copolymers in which R4 = Br and/or H and/or OH and/or group derived from spurious recombination phenomena during the radical polymerization.
⁽³⁾Number-average molar mass determined by size exclusion chromatography (SEC). The values are measured with a Varian machine equipped with Tosohaas TSK gel columns and an ionizing radiation detector. The solvent used is THF and the flow rate is set at 1 mL · min⁻¹. Calibration is performed with polystyrene standard samples of low dispersities.
⁽⁴⁾ Mass yield

Synthesis of Statistical Copolymers of Formula (II) by Atom-Transfer Radical Polymerization (ATRP)

### Example 3: Synthesis of a Dodecyl Acrylate/4-acetoxystyrene Statistical Copolymer

A solution of initiator I is prepared by dissolving 1 equivalent of octadecyl 2-bromopropionate (1 g, 405 g·mol⁻¹) in 4 mL of anisole. The solution is degassed by sparging with nitrogen. 11 equivalents of dodecyl acrylate (6.53 g, 240 g·mol⁻¹) purified beforehand on a basic alumina column, 14 equivalents of 4-acetoxystyrene (5.61 g, 162 g·mol⁻¹) purified beforehand on a basic alumina column, 0.4 equivalent of copper bromide (0.142 mg, 143 g. mol⁻¹) and 0.4 equivalent of 1,1,4,7,10,10-hexamethyltriethylenetetramine (227 mg, 230 g·mol⁻¹) are dissolved in 8 mL of anisole. The solution is degassed by sparging with nitrogen. The solution of initiator I is added under a stream of nitrogen to the monomer solution and the mixture is then placed under magnetic stirring, at 90° C., protected from light. The reaction progress is monitored by ¹H NMR spectroscopic analysis (Brüker 400 MHz spectrometer). After 17 hours at 90° C., the reaction is quenched by plunging the flask into liquid nitrogen. 100 mL of THF are added and the mixture is then passed through a basic alumina column so as to remove the catalyst. The copolymer is precipitated from 400 mL of cold methanol, centrifuged and then dried under vacuum. 10 g (mass yield of 79%) of the statistical copolymer s-I₁₈A¹²₁₀B^{ac}₁₄ are obtained after precipitation from 400 mL of cold methanol and drying under vacuum.

¹H NMR (400 MHz, 293 K, ppm in CDCl₃): δ 6.3-7.0 (m, Ar), 4.2 (t, d), 2.3 (s, g), 1.3-1.8 (m, c) 1.3 (m, b), 0.97 (t, a).

### Example 4: Synthesis of a Dodecyl Acrylate/4-acetoxystyrene Statistical Copolymer

Another statistical copolymer s-I₁₈A¹²₇B^{ac}₁₄ was synthesized according to the same protocol as in example 3, but using 7 equivalents of dodecyl acrylate instead of 11. The characteristics of the statistical copolymers obtained are collated in table 2 below:

TABLE 2

| | | | | | | | | | | | | | M_{w}⁽³⁾ | Yield ⁽⁴⁾ |
|---|---|---|---|---|---|---|---|---|---|---|---|---|---|---|
| Ref. ⁽¹⁾ | | m | n | p | R₀ | R₁ | R₂ | R₃ | R₄⁽²⁾ | R₅ | R₆ | R₇ | g · mol⁻¹ | (%) |
| s-I₁₈A¹²₁₀B^{ac}₁₄ | (II) | 1 | 10 | 14 | H | —C₁₈H₃₇ | —C₁₂H₂₅ | —OCOR₇ | Br | —CH₃ | H | —CH₃ | 6700 | 79 |
| s-I₁₈A¹²₇B^{ac}₁₄ | (II) | 1 | 7 | 14 | H | —C₁₈H₃₇ | —C₁₂H₂₅ | —OCOR₇ | Br | —CH₃ | H | —CH₃ | 7500 | 74 |

The copolymers listed in tables 1 and 2 have noteworthy properties as detergent additive in a liquid fuel, in particular in a gas oil or gasoline fuel.

The copolymers according to the invention are particularly noteworthy especially since they are efficient as detergent additive for a wide range of liquid fuels and/or for one or more types of engine specification and/or against one or more types of deposit which become formed in the internal parts of internal combustion engines.

1-25. (canceled)

26. A method comprising supplementing a liquid fuel for internal combustion engines with a copolymer detergent additive, said copolymer being obtained by copolymerization of at least:
an alkyl acrylate or alkyl methacrylate monomer (mₐ) and
a styrenyl monomer (m_{b}) chosen from styrene derivatives wherein the aromatic nucleus is substituted with at least the group R or with at least one linear or branched C₁ to C₁₂ hydrocarbon-based chain, substituted with at least one group R, said group R being chosen from:
a hydroxyl group,
a group —OR′,
a group —(OC_{y}H_{2y}O)_{f}—H,
a group —(OC_{y}H_{2y}O)_{f}—R′,
a group —O—(CO)—R′, and
a group —(CO)—OR′,
y is an integer ranging from 2 to 8, f is an integer ranging from 1 to 10 and R′ is chosen from C₁ to C₂₄ alkyl chains.

27. The method as claimed in claim 26, wherein the copolymer is a block copolymer comprising at least:
one block A consisting of a chain of structural units derived from an alkyl acrylate or alkyl methacrylate monomer (mₐ), and
one block B consisting of a chain of structural units derived from a styrenyl monomer (m_{b}).

28. The method as claimed in claim 27, wherein the block copolymer comprises at least one sequence of blocks AB, ABA or BAB in which said blocks A and B form a sequence without the presence of an intermediate block of different chemical nature.

29. The method as claimed in claim 27, wherein the block copolymer is obtained by sequenced polymerization, optionally followed by one or more post-functionalizations.

30. The method as claimed in claim 26, wherein the group R is chosen from:
a hydroxyl group, and
a group —O—(CO)—R′, R′ being chosen from C₁ to C₂₄ hydrocarbon-based chains.

31. The method as claimed in claim 26, wherein the alkyl acrylate or alkyl methacrylate monomer (mₐ) is chosen from C₁ to C₃₄ alkyl acrylates and methacrylates.

32. The method as claimed in claim 26, wherein the styrenyl monomer (m_{b}) is chosen from styrene derivatives wherein the aromatic nucleus is substituted with at least one group —O—(CO)—R′, R′ being chosen from C₁ to C₂₄ alkyls.

33. The method as claimed in claim 26, wherein the styrenyl monomer (m_{b}) is chosen from styrene derivatives wherein the aromatic nucleus is substituted with at least one hydroxyl group or with a linear or branched C₁ to C₁₂ hydrocarbon-based chain.

34. The method as claimed in claim 26, wherein the copolymer is used in a liquid fuel chosen from hydrocarbon-based fuels and fuels that are not essentially hydrocarbon-based, alone or as a mixture.

35. The method as claimed in claim 26, wherein the copolymer is used in the form of a concentrate comprising an organic liquid which is inert with respect to the copolymer and miscible in the liquid fuel.

36. The method as claimed in claim 35, wherein the copolymer is used in the form of an additive concentrate in combination with at least one fuel additive for an internal combustion engine other than said copolymer.

37. The method as claimed in any claim 26, wherein the copolymer is used in the liquid fuel to:
keep clean and/or to clean-up at least one of the internal parts of an internal combustion engine, or
limit or prevent the formation of deposits in at least one of the internal parts of an internal combustion engine, or
reduce the existing deposits in at least one of the internal parts of said engine.

38. The method as claimed in claim 26, for reducing the fuel consumption of internal combustion engines.

39. The method as claimed in claim 26, for reducing the pollutant emissions of internal combustion engines.

40. The method as claimed in claim 26, wherein the internal combustion engine is a spark ignition engine.

41. The method as claimed in claim 26, wherein the internal combustion engine is diesel engine.

42. The method as claimed in claim 41, for:
limiting or preventing and/or reducing coking-related deposits or deposits of soap type or deposits of lacquering type, or
reducing or preventing power loss due to the formation of deposits in the internal parts of a direct-injection diesel engine, said power loss being determined according to the standardized engine test method CEC F-98-08, or
reducing or preventing restriction of the fuel flow emitted by the injector of a direct-injection diesel engine during its functioning, said flow restriction being determined according to the standardized engine test method CEC F-23-1-01.

43. A process for keeping clean or for cleaning at least one of the internal parts of an internal combustion engine, comprising at least the following steps:
the preparation of a fuel composition by supplementation of a fuel with one or more copolymers as described in claim 26, and
combustion of said fuel composition in said internal combustion engine.

44. The process as claimed in claim 43, wherein the internal combustion engine is a spark ignition engine.

45. The process as claimed in claim 44, wherein the internal part of the spark ignition engine that is kept clean or cleaned is chosen from the engine intake system, the combustion chamber (CCD or TCD) and the fuel injection system.
